(19) United States
(12) Patent Application Publication
(10) Pub. No.: US 2013/0117285 A1
(43) Pub. Date: May 9, 2013

(54) SEARCH SUPPORT APPARATUS, SEARCH SUPPORT METHOD, AND SEARCH SUPPORT PROGRAM

(71) Applicant: NEC CORPORATION, Tokyo (JP)

(72) Inventor: Takamitsu ISHII, Tokyo (JP)

(73) Assignee: NEC CORPORATION, Tokyo (JP)

(21) Appl. No.: 13/671,973

(22) Filed: Nov. 8, 2012

(30) Foreign Application Priority Data
Nov. 9, 2011 (JP) 2011-245359

(51) Int. Cl. G06F 17/30

(52) U.S. Cl. 707/751; 707/E17.014

(57) ABSTRACT

Provided is a search support apparatus including: a search keyword reception unit that sequentially receives a part of search keywords input by a target user; a first ranking unit that ranks the search keywords for each user based on search history information and generates keyword ranking information; a user association degree calculation unit that calculates a degree of association of search trends between the target user and other users by using the keyword ranking information; a second ranking unit that ranks the other users based on the degree of association and generates other user ranking information; a score calculation unit that calculates a score of the search keywords matching a part of the search keywords; and an input candidate presenting unit that presents, to the target user, search keywords matching a part of the search keywords as input candidates of the search keywords in descending order of the score.

### INCORPORATION BY REFERENCE

This application is based upon and claims the benefit of priority from Japanese patent application No. 2011-245359, filed on Nov. 9, 2011, the disclosure of which is incorporated herein in its entirety by reference.

### BACKGROUND OF THE INVENTION

1. Technical Field

The present invention relates to a search support apparatus, a search support method, and a search support program.

2. Background Art

The amount of information resources available on websites is increasing day by day. Along with this, the number of search targets of search engines is also increasing day by day. Under such circumstances, in order for a user to smoothly reach target information by using a search engine, it is important to improve the accuracy of the search engine and optimize the input of search keywords.

Japanese Unexamined Patent Application Publication No. 2007-148476 discloses an information search support system that causes a user to select a search method depending on the status or object at that time and provides a content searched based on the selected search method. Japanese Unexamined Patent Application Publication No. 2010-176198 discloses an information search method for providing a content searched in consideration of trends.

The information search support system disclosed in Japanese Unexamined Patent Application Publication No. 2007-148476 causes a user to select a search support module and provides the user with the search result obtained by the search method presented according to the search support module. However, this search support system can present only search conditions compatible with the search support module, and cannot present search conditions incompatible with the search support module. Accordingly, it cannot be said that the search support system smoothly supports the user to reach desired information.

In the information search method disclosed in Japanese Unexamined Patent Application Publication No. 2010-176198, a weighting factor is calculated based on a valid term of a content and an elapsed time from a last search, and the content is provided according to a search rank determined based on the weighting factor and the number of clicks on the searched content. Although this search method can provide the content in consideration of trends, it cannot be said that the search method supports the user to reach desired information.

### SUMMARY

The present invention has been made to solve the above-mentioned problem, and an exemplary object of the present invention is to provide a search support apparatus, a search support method, and a search support program which are capable of smoothly supporting a user to reach desired information.

In a first exemplary aspect of the invention, a search support apparatus includes: a search keyword reception unit that sequentially receives a part of search keywords input by a target user; a search history information storage unit that stores, for each user, search history information including the search keywords used for a search; a first ranking unit that ranks the search keywords for each user based on the search history information, and generates keyword ranking information; a user association degree calculation unit that calculates a degree of association of search trends between the target user and other users by using the keyword ranking information; a second ranking unit that ranks the other users based on the degree of association calculated by the user association degree calculation unit, and generates other user ranking information; a score calculation unit that calculates a score corresponding to each search keyword matching a part of the search keywords received by the search keyword reception unit, among the search keywords included in the search history information, by using the keyword ranking information and the other user ranking information; and an input candidate presenting unit that presents, to the target user, the search keywords matching a part of the search keywords, as input candidates of the search keywords in descending order of the score calculated by the score calculation unit.

In a second exemplary aspect of the invention, a search support method includes: a search keyword reception step of sequentially receiving a part of search keywords input by a target user; a first ranking step of ranking the search keywords for each user based on search history information including the search keywords used for a search, and generating keyword ranking information; a user association degree calculation step of calculating a degree of association of search trends between the target user and other users by using the keyword ranking information; a second ranking step of ranking the other users based on the degree of association calculated in the user association degree calculation step, and generating other user ranking information; a score calculation step of calculating a score corresponding to each search keyword matching a part of the search keywords received in the search keyword reception step, among the search keywords included in the search history information, by using the keyword ranking information and the other user ranking information; and an input candidate presenting step of presenting, to the target user, the search keywords matching a part of the search keywords, as input candidates of the search keywords in descending order of the score calculated in the score calculation step.

In a third exemplary aspect of the invention, a search support program causes a computer to execute the steps included in the search support method according to the second exemplary aspect of the invention.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

The above and other aspects, features, and advantages of the present invention will become more apparent from the following description of certain exemplary embodiments when taken in conjunction with the accompanying drawings, in which:

FIG. 1 is a diagram illustrating a configuration of a search support apparatus according to an exemplary embodiment;

FIG. 2 is a table illustrating search keyword ranking information;

FIG. 3 is a table for explaining a method for calculating a degree of association;

FIG. 4 is a flowchart for explaining a procedure for calculating the degree of association of search trends between users;

FIG. 5 is a table illustrating other user ranking information;

FIG. 6 is a table for explaining a method for calculating a final score;

FIG. 7 is a table for explaining a method for calculating a final score;

FIG. 8 is a table illustrating input candidate ranking information;

FIG. 9 is a flowchart for explaining a procedure for presenting input candidates of search keywords to a target user; and

FIG. 10 is a diagram illustrating a minimum configuration of a search support apparatus according to an exemplary embodiment of the present invention.

### EXEMPLARY EMBODIMENT

Hereinafter, exemplary embodiments of a search support apparatus, a search support method, and a search support program according to the present invention will be described with reference to the accompanying drawings.

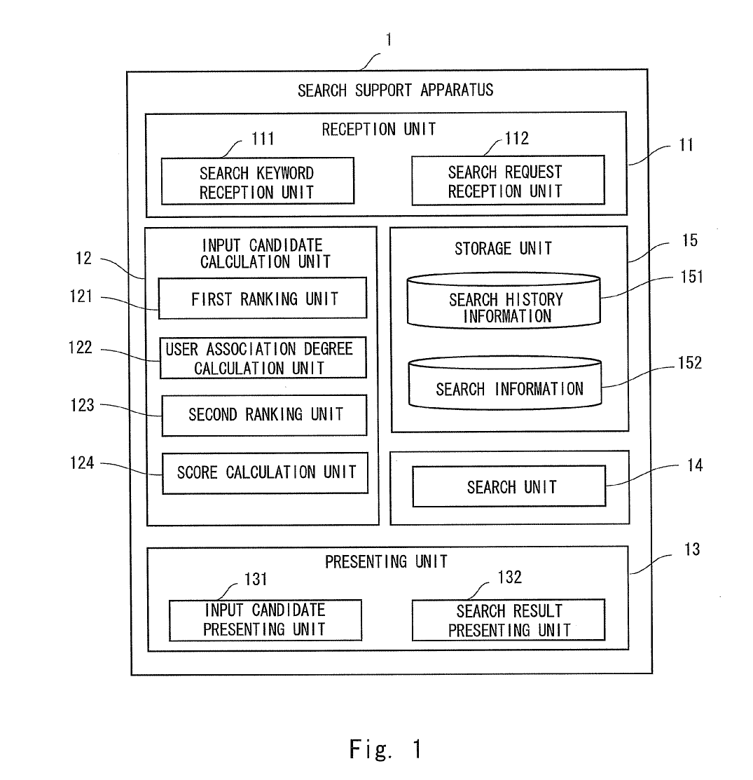

Referring first to FIG. 1, a configuration of a search support apparatus according to an exemplary embodiment will be described. A search support apparatus 1 functionally includes a reception unit 11, an input candidate calculation unit 12, a presenting unit 13, and a search unit 14, for example. The search support apparatus 1 also includes a storage unit 15 including a search history information storage unit 151 and a search information storage unit 152 which are referred to by each of the above-mentioned units.

The search support apparatus 1 physically includes a CPU (Central Processing Unit), a storage device, and an input/output interface, for example. Examples of the storage device include a ROM (Read Only Memory) and an HDD (Hard Disk Drive), which store programs and data to be processed by the CPU, and a RAM (Random Access Memory) which is used as various areas mainly for control processing. These elements are connected via buses. The CPU executes programs stored in the ROM, and processes messages received via the input/output interface, data developed in the RAM, and the like, thereby implementing the functions of each unit of the search support apparatus 1.

The reception unit 11 receives various messages and data which are input in accordance with an operation instruction of a user. The reception unit 11 includes a search keyword reception unit 111 and a search request reception unit 112. The reception unit 11 may receive various messages and data from an input device, such as a keyboard, which is attached to the search support apparatus 1, or from a client terminal which is connectable via a network.

The search keyword reception unit 111 sequentially receives a part of search keywords input by a target user. The term “target user” refers to a user who is inputting search keywords at the present time among users using the search support apparatus 1.

The search request reception unit 112 receives a search request issued when the target user determines the input of search keywords and executes a search.

The input candidate calculation unit 12 calculates other search keywords which match a part of the search keywords input by the target user and which can support the target user to reach desired information. The input candidate calculation unit 12 includes a first ranking unit 121, a user association degree calculation unit 122, a second ranking unit 123, and a score calculation unit 124.

The first ranking unit 121 refers to search history information stored in the search history information storage unit 151, and ranks the search keywords for each user, thereby generating keyword ranking information.

Examples of the search history information include user identification information for uniquely identifying a user, search keywords used by the user during a search, and the number of searches using the search keywords.

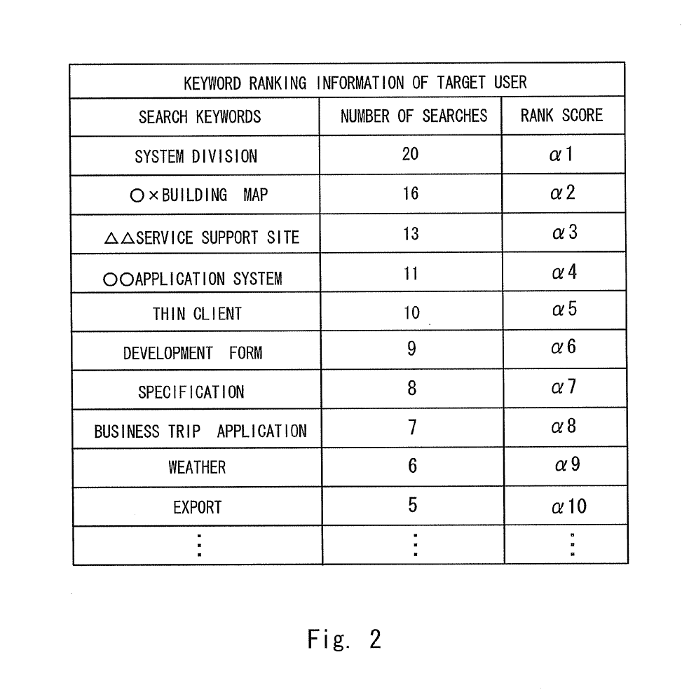

As illustrated in FIG. 2, the search keyword ranking information includes search keywords used by a user during a search, the number of searches using the search keywords, and a rank score for each of the search keywords, for example.

Referring to FIG. 2, the functions of the first ranking unit 121 will be described in detail. The first ranking unit 121 refers to the search history information for each user identification information, and ranks the search key words in descending order of the number of searches. The first ranking unit 121 calculates each rank score according to the ranking order of the search keywords. For example, the rank scores from the first rank to the n-th rank (lowest rank) are calculated as α1, α2, α3, . . . , αn (α1>α2>α3> . . . >αn) according to the ranking order. Note that it is not always necessary to satisfy the relation α1>α2>α3> . . . >αn. Further, different values may be set to rank scores having the same rank between users.

The user association degree calculation unit 122 illustrated in FIG. 1 calculates the degree of association of search trends between the target user and other users, who are users other than the target user, by using the keyword ranking information. The degree of association of search trends can be obtained by calculating the similarity of search keyword input histories between users.

Specifically, the user association degree calculation unit 122 refers to the keyword ranking information of the target user and the keyword ranking information of other users, and multiplies and adds the rank scores of search keywords included in the both information items, thereby calculating the degree of association.

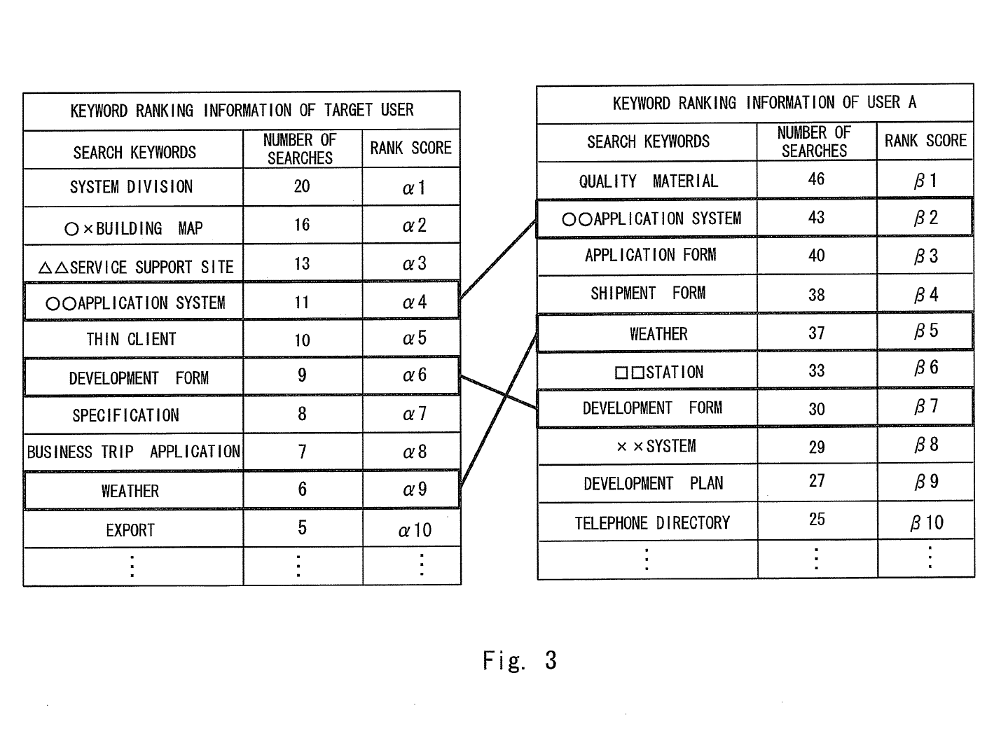

Referring to FIG. 3, a method for calculating the degree of association will be described in detail. The search keywords that are common to the key ranking information of the target user and the keyword ranking information of a user A are “oo application system”, “development form”, and “weather”. Accordingly, the value obtained by accumulating the products of the rank scores of the common search keywords is expressed as “(α4×β2)+(α6×β7)+(α9×β5)”. Thus, a degree of association γ of search trends between the target user and the user A is expressed as “(α4×β2)+(α6×β7)+(α9×β5)”.

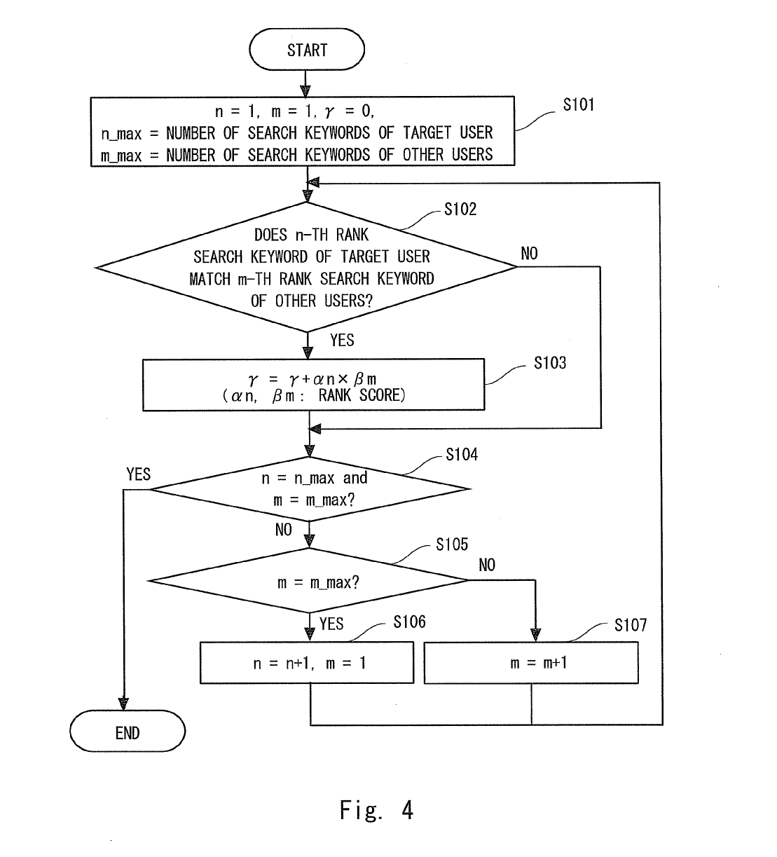

Referring to FIG. 4, a procedure for calculating the degree of association between the target user and other users will be described.

First, the user association degree calculation unit 122 sets “1” to each of “n” and “m”; “0” to “γ”; the number of search keywords of the target user to “n_max”; and the number of search keywords of other users to “m_max” (step S101).

Subsequently, the user association degree calculation unit 122 determines whether or not the “n”-th rank search keyword of the target user matches the “m”-th rank search keyword of other users (step S102). When the determination result is NO (step S102; NO), the process shifts to step S104 which is described later.

On the other hand, when it is determined that the keywords match each other in the determination of step S102 described above (step S102; YES), the user association degree calculation unit 122 calculates “γ=γ+αn×βm” (step S103). Here, “αn” represents the “n”-th rank score of the target user and “βm” represents the “m”-th rank score of other users.

Next, the user association degree calculation unit 122 determines whether or not each of “n=n_max” and “m=m_max” holds (step S104). When the determination result is YES (step S104; YES), the process is ended.

On the other hand, when the determination result in step S104 described above is NO (step S104; NO), the user association degree calculation unit 122 determines whether or not “m=m_max” holds (step S105). When the determination result is YES (step S105; YES), the user association degree calculation unit 122 adds “n” to “1” and sets “1” to “m” (step S106). After that, the process shifts to step S102 described above.

On the other hand, when the determination result in step S105 described above is NO (step S105; NO), the user association degree calculation unit 122 adds “1” to “m” (step S107). After that, the process shifts to step S102 described above.

Note that the method for calculating the degree of association is not limited to the above-described method. Other calculation methods may be employed, as long as the methods satisfy the following requirements (1) and (2).

(1) If the search histories of other users include a larger number of search keywords included in the search history of the target user, a higher degree of association is set.

(2) If search keywords ranked higher (the number of searches is greater) in the search history of the target user are also ranked higher in the search history of the target user, a higher degree of association is set.

The second ranking unit 123 illustrated in FIG. 1 ranks other users in descending order of the degree of association calculated by the user association degree calculation unit 122, thereby generating the other user ranking information.

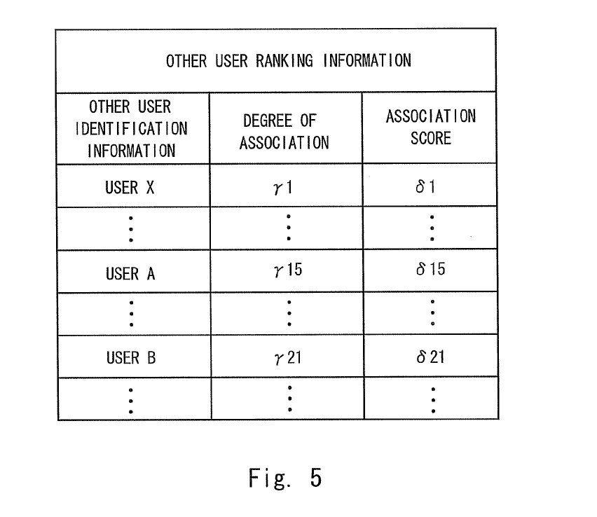

As illustrated in FIG. 5, examples of the other user ranking information include user identification information of other users, the degree of association between the target user and other users, and association scores for other users. Each association score can be appended according to the degree of association. Note that each association score may be set to a value different from the degree of association, or may be set to the same value as the degree of association.

Referring to FIG. 5, the functions of the second ranking unit 123 will be described in detail. The second ranking unit 123 ranks other users in descending order of the degree of association calculated by the user association degree calculation unit 122. The second ranking unit 123 calculates each association score according to the degree of association of each of other users. For example, association scores (γ1, γ2, γ3, . . . , γk) from the first rank to the k-th rank (lowest order) are calculated as δ1, δ2, δ3, . . . , δk according to each degree of association.

The other user ranking information illustrated in FIG. 5 indicates that the other user having a highest degree of association with the target user corresponds to “user X”; the other user having a 15-th highest degree of association with the target user corresponds to “user A”; and the other user having a 21-st highest degree of association with the target user corresponds to “user B”.

The score calculation unit 124 illustrated in FIG. 1 calculates a score corresponding to each search keyword matching a part of search keywords received by the search keyword reception unit 111 among the search keywords included in the search history information. This score is a final score. The score calculation unit 124 refers to the keyword ranking information and other user ranking information during calculation of the score.

The score calculation method of the score calculation unit 124 will be described in detail below. The score calculation unit 124 refers to each keyword ranking information, and detects other search keywords matching a part of the search keywords input by the target user. The score calculation unit 124 acquires, from the other user ranking information, the association score of the other user corresponding to the keyword ranking information storing the detected other search keyword. The score calculation unit 124 multiplies the rank score corresponding to the detected other search keyword and the acquired association score, thereby calculating the final score of the other detected search keyword.

Referring to FIGS. 5 to 8, the calculation method will be described in more detail. In the following description, the case where a part of the search keywords received by the search keyword reception unit 111 is “shi (hiragana character)” will be described.

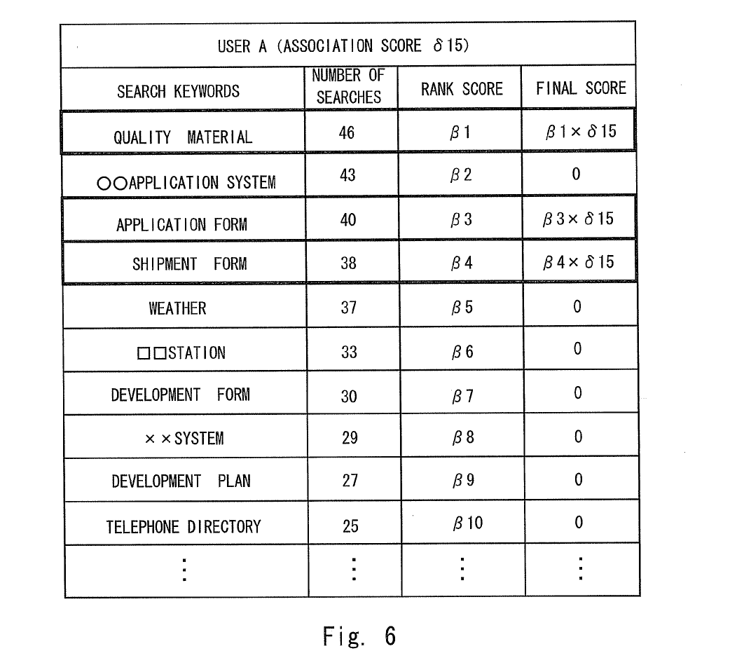

Among the search keywords included in the keyword ranking information of the user A illustrated in FIG. 6, three search keywords match each other with “shi (hiragana character)”. The three keywords are “quality material”, “application form”, and “shipment form”. Referring to the keyword ranking information of the user A illustrated in FIG. 6, the rank score for “quality material” is “(β1”; the rank score for “application form” is “(β3”; and the rank score for “shipment form” is “(β4”. Referring to the other user ranking information illustrated in FIG. 5, the association score for “user A” is “δ15”.

Accordingly, the score calculation unit 124 calculates “(β1×δ15” as the final score for “quality material”, calculates “β3×δ15” as the final score for “application form”, and calculates “β4×δ15” as the final score for “shipment form”. Further, the score calculation unit 124 sets “0” as the final score for the search keywords that do not include “shi (hiragana character)”.

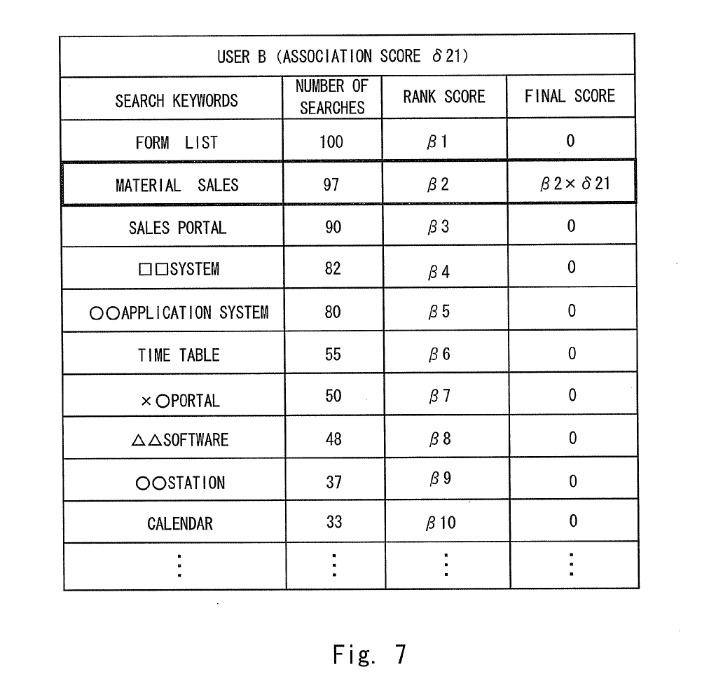

Among the search keywords included in the keyword ranking information of the user B illustrated in FIG. 7, the search keyword including “shi (hiragana character)” is “material sales”. Referring to the keyword ranking information of the user B illustrated in FIG. 7, the rank score for “material sales” is “β2”. Referring to the other user ranking information illustrated in FIG. 5, the association score for “user B” is “δ21”.

Accordingly, the score calculation unit 124 calculates “β2×δ21” as the final score for “material sales”. Further, the score calculation unit 124 sets “0” as the final score for the search keywords that do not include “shi (hiragana character)”.

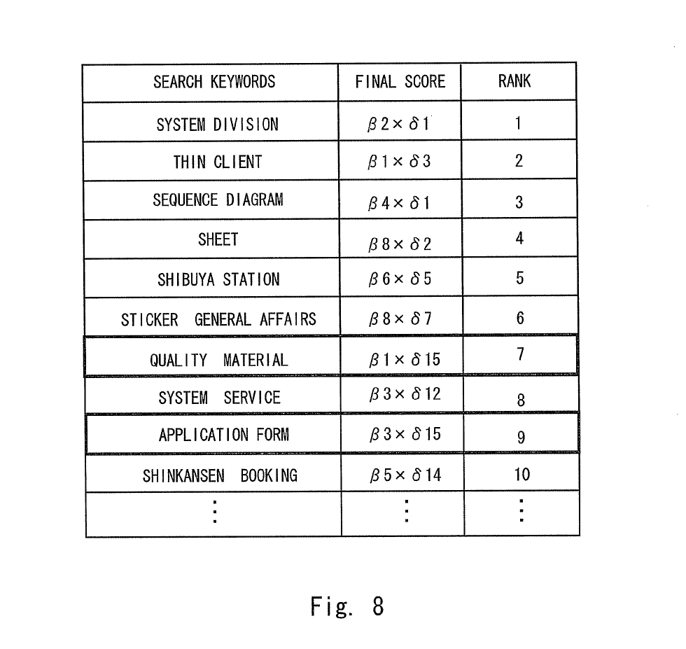

The score calculation unit 124 performs the above-described final score calculation on the keyword ranking information for all other users. The score calculation unit 124 ranks the search keywords other than search keywords having a final score of “0”, on the basis of the final scores, thereby generating input candidate ranking information illustrated in FIG. 8. In this case, when there is a plurality of identical search keywords, a search keyword having a highest final score is adopted as the input candidate ranking information.

In the input candidate ranking information illustrated in FIG. 8, “quality material” included in the keyword ranking information of the user A illustrated in FIG. 6 is ranked “7”-th among the input candidates, and “application form” included in the keyword ranking information of the user A illustrated in FIG. 6 is ranked “9”-th among the input candidates.

The presenting unit 13 illustrated in FIG. 1 presents various information to the target user. The presenting unit 13 may cause a display device, such as a display attached to the search support apparatus 1, to display various information, or may transmit information to a connectable client terminal via a network and cause the client terminal to display the information. The presenting unit 13 includes an input candidate presenting unit 131 and a search result presenting unit 132.

The input candidate presenting unit 131 presents, to the target user, the search keywords included in the input candidate ranking information, as input candidates of search keywords. The input candidate presenting unit 131 presents the search keywords in descending order of the final score.

In the input candidate ranking information illustrated in FIG. 8, “system division”, “thin client”, “sequence diagram”, “sheet”, . . . are presented in this order to the target user as input candidates of the search keyword for the character “shi (hiragana character)” that is input by the target user.

When the search request reception unit 112 receives a search request, the search unit 14 illustrated in FIG. 1 acquires, from the search information storage unit 152, index information corresponding to the search keywords included in the search request. The term “search request” refers to a message issued when the target user determines the input of search keywords and inputs a search execution instruction. The search request includes search keywords. The search information storage unit 152 is a database that stores the index information for searching as search information.

The search unit 14 correlates the search keywords included in the search request with the user identification information of the target user, to thereby generate the search history information, and stores the search history information in the search history information storage unit 151.

The search result presenting unit 132 presents, to the target user, the index information acquired by the search unit 14 as the search result.

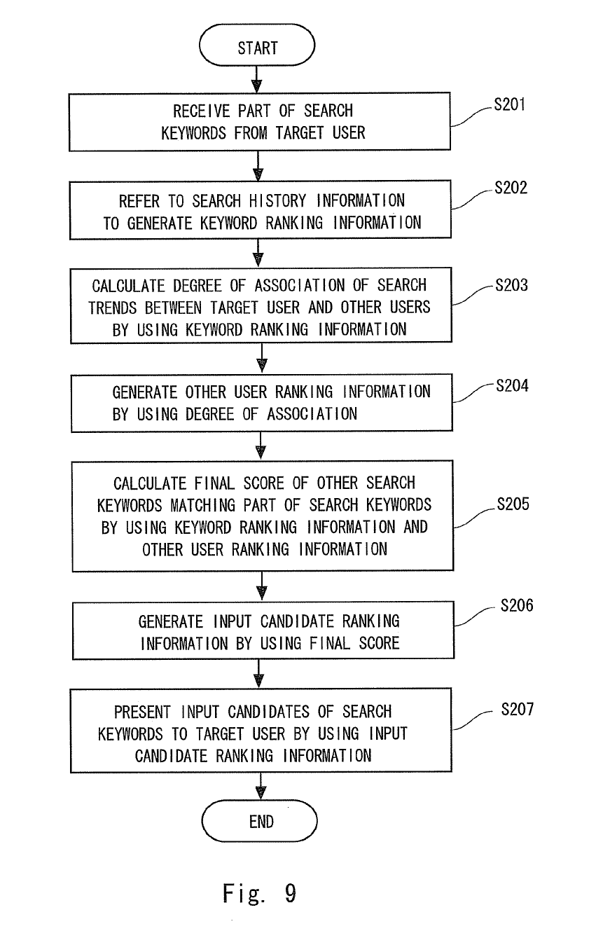

Referring next to FIG. 9, a procedure in which the search support apparatus 1 presents input candidates of search keywords to the target user will be described.

First, the search keyword reception unit 111 receives a part of the search keywords input by the target user (step S201).

Subsequently, the first ranking unit 121 refers to the search history information stored in the search history information storage unit 151, and generates keyword ranking information for each user (step S202).

Next, the user association degree calculation unit 122 calculates the degree of association of search trends between the target user and other users by using the keyword ranking information generated in step S202 described above (step S203).

The second ranking unit 123 then generates other user ranking information by using the degree of association calculated in step S203 described above (step S204).

The score calculation unit 124 then calculates the final score of each of other search keywords matching a part of the search keywords received in step S201 described above, by using the keyword ranking information generated in step S202 described above and the other user ranking information generated in step S204 described above (step S205).

The score calculation unit 124 then generates input candidate ranking information by using the final scores calculated in the step S205 described above (step S206).

The input candidate presenting unit 131 then presents input candidates of search keywords to the target user by using the input candidate ranking information generated in step S206 described above (step S207).

As described above, according to the search support apparatus 1 of an exemplary embodiment of the present invention, the first ranking unit 121 can generate keyword ranking information by ranking search keywords in descending order of the number of searches for each user; the user association degree calculation unit 122 can calculate the degree of association of search trends between the target user and other users by using the keyword ranking information; and the second ranking unit 123 can generate other user ranking information by ranking other users in descending order of the degree of association.

Moreover, the search keyword reception unit 111 can receive a part of search keywords; the score calculation unit 124 can calculate the final score of each of other search keywords matching a part of the search keywords by using the keyword ranking information and the other user ranking information; and the input candidate presenting unit 131 can present other search keywords to the target user in descending order of the final score.

Thus, the search support apparatus 1 according to an exemplary embodiment of the present invention can provide input candidates of search keywords depending on the user characteristics, every time the user inputs a part of the search keywords. This makes it possible to smoothly support the user to reach desired information.

### Modified Example

The above-described exemplary embodiments are shown for illustrative purposes only and are not intended to exclude various modifications and technical applications not explicitly described in the embodiments. In other words, various modifications of the present invention are available without departing from the spirit and scope of the present invention.

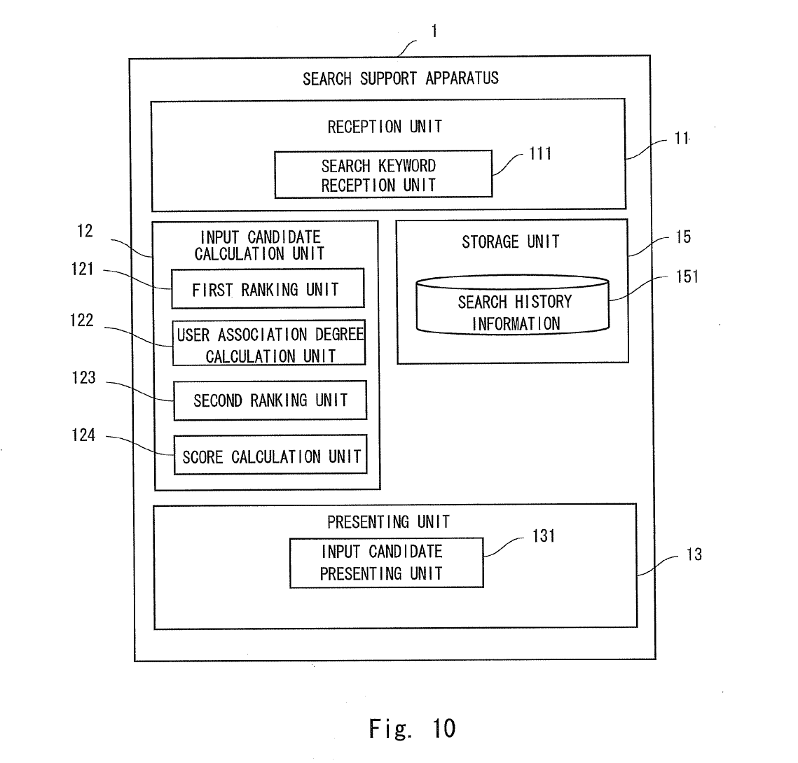

For example, the search support apparatus according to the exemplary embodiment described above includes the functions illustrated in FIG. 1 as components, but the configuration of the search support apparatus according to the present invention is not limited thereto. A minimum configuration of the present invention will be described. FIG. 10 is a diagram illustrating the minimum configuration of the search support apparatus according to the present invention. The search support apparatus illustrated in FIG. 10 is an apparatus that is specialized in the functions of calculating input candidates of search keywords based on a part of input search keywords and presenting the calculation result, among the functions included in the search support apparatus illustrated in FIG. 1. Specifically, in the search support apparatus illustrated in FIG. 10, the search request reception unit 112, the search unit 14, and the search result presenting unit 132 (which are functions for searching using the determined search keywords and presenting the search result) are omitted from the functions included in the search support apparatus illustrated in FIG. 1, and the search information storage unit 152 is also omitted.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The configuration described above makes it possible to smoothly support the user to reach desired information, for example.

The whole or part of the exemplary embodiments disclosed above can be described as, but not limited to, the following supplementary notes.

(Supplementary note 1) A search support apparatus including: a search keyword reception unit that sequentially receives a part of search keywords input by a target user; a search history information storage unit that stores, for each user, search history information including the search keywords used for a search; a first ranking unit that ranks the search keywords for each user based on the search history information, and generates keyword ranking information; a user association degree calculation unit that calculates a degree of association of search trends between the target user and other users by using the keyword ranking information; a second ranking unit that ranks the other users based on the degree of association calculated by the user association degree calculation unit, and generates other user ranking information; a score calculation unit that calculates a score corresponding to each search keyword matching a part of the search keywords received by the search keyword reception unit, among the search keywords included in the search history information, by using the keyword ranking information and the other user ranking information; and an input candidate presenting unit that presents, to the target user, the search keywords matching a part of the search keywords, as input candidates of the search keywords in descending order of the score calculated by the score calculation unit.

(Supplementary note 2) The search support apparatus according to Supplementary note 1, wherein the first ranking unit ranks, for each user, the search keywords in descending order of the number of searches based on the search keywords included in the search history information, calculates a rank score according to the ranking, and generates the search keyword ranking information by using the search keyword and the rank score.

(Supplementary note 3) The search support apparatus according to Supplementary note 2, wherein the second ranking unit ranks the other users in descending order of the degree of association calculated by the user association degree calculation unit, calculates an association score according to the degree of association, and generates other user ranking information by using identification information for identifying the other users and the association score.

(Supplementary note 4) The search support apparatus according to Supplementary note 3, wherein the score calculation unit calculates the score by multiplying the rank score included in the keyword ranking information by the association score included in the other user ranking information.

(Supplementary note 5) The search support apparatus according to any one of Supplementary notes 1 to 4, wherein the search history information storage unit stores the search history information that correlates the search keywords with identification information for identifying the target user.

(Supplementary note 6) The search support apparatus according to any one of Supplementary notes 1 to 5, further comprising a search result presenting unit that presents, to the target user, a search result corresponding to the search keywords, upon reception of a search request including the search keywords.

(Supplementary note 7) A search support method including: a search keyword reception step of sequentially receiving a part of search keywords input by a target user; a first ranking step of ranking the search keywords for each user based on search history information including the search keywords used for a search, and generating keyword ranking information; a user association degree calculation step of calculating a degree of association of search trends between the target user and other users by using the keyword ranking information; a second ranking step of ranking the other users based on the degree of association calculated in the user association degree calculation step, and generating other user ranking information; a score calculation step of calculating a score corresponding to each search keyword matching a part of the search keywords received in the search keyword reception step, among the search keywords included in the search history information, by using the keyword ranking information and the other user ranking information; and an input candidate presenting step of presenting, to the target user, the search keywords matching a part of the search keywords, as input candidates of the search keywords in descending order of the score calculated in the score calculation step.

(Supplementary note 8) A search support program for causing a computer to execute the steps according to Supplementary note 7.

What is claimed is:

1. A search support apparatus comprising:
a search keyword reception unit that sequentially receives a part of search keywords input by a target user;
a search history information storage unit that stores, for each user, search history information including the search keywords used for a search;
a first ranking unit that ranks the search keywords for each user based on the search history information, and generates keyword ranking information;
a user association degree calculation unit that calculates a degree of association of search trends between the target user and other users by using the keyword ranking information;
a second ranking unit that ranks the other users based on the degree of association calculated by the user association degree calculation unit, and generates other user ranking information;
a score calculation unit that calculates a score corresponding to each search keyword matching a part of the search keywords received by the search keyword reception unit, among the search keywords included in the search history information, by using the keyword ranking information and the other user ranking information; and
an input candidate presenting unit that presents, to the target user, the search keywords matching a part of the search keywords, as input candidates of the search keywords in descending order of the score calculated by the score calculation unit.

2. The search support apparatus according to claim 1, wherein the first ranking unit ranks, for each user, the search keywords in descending order of the number of searches based on the search keywords included in the search history information, calculates a rank score according to the ranking, and generates the search keyword ranking information by using the search keyword and the rank score.

3. The search support apparatus according to claim 2, wherein the second ranking unit ranks the other users in descending order of the degree of association calculated by the user association degree calculation unit, calculates an association score according to the degree of association, and generates other user ranking information by using identification information for identifying the other users and the association score.

4. The search support apparatus according to claim 3, wherein the score calculation unit calculates the score by multiplying the rank score included in the keyword ranking information by the association score included in the other user ranking information.

5. The search support apparatus according to claim 1, wherein the search history information storage unit stores the search history information that correlates the search keywords with identification information for identifying the target user.

6. The search support apparatus according to claim 1, further comprising a search result presenting unit that presents, to the target user, a search result corresponding to the search keywords, upon reception of a search request including the search keywords.

7. A search support method comprising:
a search keyword reception step of sequentially receiving a part of search keywords input by a target user;
a first ranking step of ranking the search keywords for each user based on search history information including the search keywords used for a search, and generating keyword ranking information;
a user association degree calculation step of calculating a degree of association of search trends between the target user and other users by using the keyword ranking information;
a second ranking step of ranking the other users based on the degree of association calculated in the user association degree calculation step, and generating other user ranking information;
a score calculation step of calculating a score corresponding to each search keyword matching a part of the search keywords received in the search keyword reception step, among the search keywords included in the search history information, by using the keyword ranking information and the other user ranking information; and
an input candidate presenting step of presenting, to the target user, the search keywords matching a part of the search keywords, as input candidates of the search keywords in descending order of the score calculated in the score calculation step.

8. A non-transitory computer readable medium storing a search support program for causing a computer to execute the steps according to claim 7.
